(19) United States
(12) Patent Application Publication
(10) Pub. No.: US 2019/0219412 A1
(43) Pub. Date: Jul. 18, 2019

(54) ELECTRIFIED VEHICLE ROUTE PLANNING THAT IS PARTIALLY BASED ON FORECASTED WEATHER CONDITIONS

(71) Applicant: Ford Global Technologies, LLC, Dearborn, MI (US)

(72) Inventors: Anthony Melatti, Dearborn, MI (US); George Vrampas, Southgate, MI (US); Daniel Sullivan, Grosse Pointe, MI (US); Youssef El-minyawi, Canton, MI (US)

(21) Appl. No.: 15/872,074

(22) Filed: Jan. 16, 2018

(51) Int. Cl. G01C 21/34; B60W 50/00; G01C 21/36; B60W 20/00

(52) U.S. Cl. CPC G01C 21/3469; B60W 50/0097; G01C 21/3667; B60Y 2200/92; B60W 20/00; B60W 2550/12; Y10S 903/903; G01C 21/3697

(57) ABSTRACT

An exemplary electrified vehicle assembly includes, among other things, a controller that uses both a set temperature for inside a passenger cabin and a weather condition outside the passenger cabin to provide a predicted energy consumption for an electrified vehicle along a potential route to a destination. An exemplary route planning method includes, among other things, using a both a set temperature for inside a passenger cabin and a weather condition outside the passenger cabin to provide a predicted energy consumption for a potential route to a destination.

### TECHNICAL FIELD

This disclosure is directed toward route planning for an electrified vehicle and, more particularly, to route planning that can be based on forecasted weather conditions and interior climate temperature settings.

### BACKGROUND

Generally, electrified vehicles differ from conventional motor vehicles because electrified vehicles are selectively driven using one or more battery-powered electric machines. Conventional motor vehicles, by contrast, rely exclusively on an internal combustion engine to drive the vehicle. Electrified vehicles may use electric machines instead of, or in addition to, the internal combustion engine.

Example electrified vehicles include hybrid electrified vehicles (HEVs), plug-in hybrid electrified vehicles (PHEVs), fuel cell vehicles, and battery electrified vehicles (BEVs). A powertrain of an electrified vehicle is typically equipped with a battery pack having battery cells that store electrical power for powering the electric machine. The battery cells may be charged prior to use. The battery cells may be recharged during a drive by regeneration braking or an internal combustion engine. Operating the battery cells within an optimum temperature range can be more efficient than operating the battery cells outside the optimum temperature range.

The battery cells can be used to power many loads on the vehicle, including cabin heating and air conditioning systems. Energy consumed by the battery cells can vary depending on heating and cooling requirements, and weather conditions outside the electrified vehicle.

### SUMMARY

An electrified vehicle assembly according to an exemplary embodiment of the present disclosure includes, among other things, a controller that use both a set temperature for inside a passenger cabin and a weather condition outside the passenger cabin to provide a predicted energy consumption for an electrified vehicle along at least one potential route to a destination.

In a further non-limiting embodiment of the foregoing assembly, the set temperature for the passenger cabin is a user-adjustable range of temperatures.

In a further non-limiting embodiment of the foregoing assembly, the weather condition outside of the passenger cabin comprises a forecasted weather condition for the potential route.

In a further non-limiting embodiment of the foregoing assembly, the one potential route is a plurality of potential routes, and the controller is configured to compare the predicted energy consumption for each of the plurality of potential routes and to provide the preferred route.

A further non-limiting embodiment of the foregoing assembly includes a display screen within the passenger compartment. The controller provides the preferred route by initiating a display of the preferred route on the display.

In a further non-limiting embodiment of the foregoing assembly, the preferred route is the route or routes within the plurality of potential routes with the predicted energy consumption being the lowest.

In a further non-limiting embodiment of the foregoing assembly, a potential energy savings is provided to a user if another of the plurality of potential routes to the destination is selected.

In a further non-limiting embodiment of the foregoing assembly, the controller is a hybrid powertrain control module.

In a further non-limiting embodiment of the foregoing assembly, the weather condition comprises a temperature.

In a further non-limiting embodiment of the foregoing assembly, the weather condition comprises a wind speed.

A route planning method according to another exemplary embodiment of the present disclosure includes, among other things, using both a set temperature for inside a passenger cabin and a weather condition outside the passenger cabin to provide a predicted energy consumption for at least one potential route to a destination.

In a further non-limiting embodiment of the method, the set temperature for the passenger cabin is a user-adjustable range of temperatures.

In a further non-limiting embodiment of any of the foregoing methods, the weather condition outside of the passenger cabin comprises a forecasted weather condition for the potential route.

In a further non-limiting embodiment of any of the foregoing methods the potential route is a plurality of potential routes. The method includes comparing the predicted energy consumption for each of the plurality of potential routes to provide a preferred route.

A further non-limiting embodiment of any of the foregoing methods includes displaying the preferred route on a display.

In a further non-limiting embodiment of the method, the preferred route is the route or routes within the plurality of potential routes with the predicted energy consumption being the lowest.

In a further non-limiting embodiment of the method, a potential energy savings is provided to a user for some of the plurality of potential routes to the destination.

In a further non-limiting embodiment of the method, the weather condition comprises a temperature.

In a further non-limiting embodiment of the method, the weather condition comprises a wind speed.

A further non-limiting embodiment of the method can include using an optimal powertrain temperature setting when providing the predicted energy consumption. The optimal powertrain temperature setting includes a preferred temperature setting for a battery pack of a vehicle having the passenger cabin, an electric motor of the vehicle, or both.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DESCRIPTION OF THE FIGURES

The various features and advantages of the disclosed examples will become apparent to those skilled in the art from the detailed description. The figures that accompany the detailed description can be briefly described as follows:

FIG. 1 schematically illustrates an example electrified vehicle powertrain.

FIG. 2 schematically illustrates an electrified vehicle incorporating the powertrain of FIG. 1.

FIG. 3 illustrates a plurality of potential routes for the electrified vehicle of FIG. 2 to take to the destination.

FIG. 4 illustrates a table of forecasted weather condition information about the potential routes in FIG. 3.

FIG. 5 schematically illustrates the flow of an exemplary route planning method utilized by the vehicle of FIG. 2 according to an exemplary embodiment.

FIG. 6 schematically illustrates the flow of a method of monitoring for energy efficient routes to a destination according to another exemplary embodiment.

FIG. 7 schematically illustrates the flow of a method of identifying a preferred, energy efficient route to a destination according to yet another exemplary embodiment.

### DETAILED DESCRIPTION

This disclosure relates generally to selecting a route for an electrified vehicle to travel to a destination.

The selecting can be based on which route will consume the least energy. To predict energy consumption, the selecting process takes into account a user's desired temperature for within a passenger cabin of the electrified vehicle, and additionally takes into account forecasted weather conditions along various potential routes to the destination. Taking these factors into account can help to more accurately predict the energy consumption along the potential routes.

FIG. 1 schematically illustrates a powertrain 10 for an electrified vehicle. Although depicted as a hybrid electrified vehicle (HEV), it should be understood that the concepts described herein are not limited to HEVs and could extend to other electrified vehicles, including, but not limited to, plug-in hybrid electrified vehicles (PHEVs), fuel cell vehicles, and battery electrified vehicles (BEVs).

In one embodiment, the powertrain 10 is a powersplit powertrain system that employs a first drive system and a second drive system. The first drive system includes a combination of an engine 14 and a generator 18 (i.e., a first electric machine). The second drive system includes at least a motor 22 (i.e., a second electric machine), the generator 18, and a battery pack 24. In this example, the second drive system is considered an electric drive system of the powertrain 10. The first and second drive systems generate torque to drive one or more sets of vehicle drive wheels 28 of the electrified vehicle.

The engine 14, which is an internal combustion engine in this example, and the generator 18 may be connected through a power transfer unit 30. In one non-limiting embodiment, the power transfer unit 30 is a planetary gear set that includes a ring gear 32, a sun gear 34, and a carrier assembly 36. Of course, other types of power transfer units, including other gear sets and transmissions, may be used to connect the engine 14 to the generator 18.

The generator 18 can be driven by engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In this example, the second power transfer unit 44 is mechanically coupled to an axle 50 through the differential 48 to distribute torque to the vehicle drive wheels 28.

The motor 22 (i.e., the second electric machine) can also be employed to drive the vehicle drive wheels 28 by outputting torque to a shaft 52 that is also connected to the second power transfer unit 44. In one embodiment, the motor 22 and the generator 18 cooperate as part of a regenerative braking system in which both the motor 22 and the generator 18 can be employed as motors to output torque. For example, the motor 22 and the generator 18 can each output electrical power to the battery pack 24.

The battery pack 24 is an example type of electrified vehicle battery assembly. The battery pack 24 may have the form of a high-voltage battery that is capable of outputting electrical power to operate the motor 22 and the generator 18. Other types of energy storage devices and/or output devices can also be used with the electrified vehicle having the powertrain 10. The battery pack 24 is a traction battery pack as the battery pack 24 can provide power to propel the wheels 28.

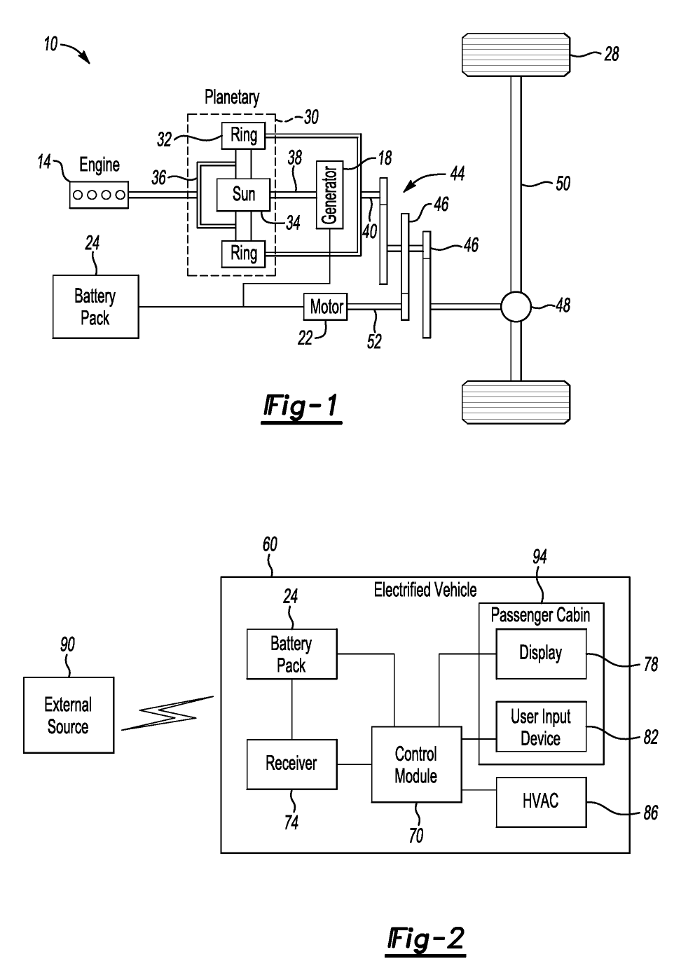

Referring now to FIG. 2 with continuing reference to FIG. 1, an electrified vehicle 60 can incorporate the powertrain 10. The vehicle 60 further includes a control module 70, a receiver 74, a display 78, a user input device 82, and a heating, ventilation, and air conditioning (HVAC) system 86.

The receiver 74 can receive information from an external source 90 that is outside the vehicle 60 and remote from the vehicle 60. The receiver 74 can be a telematics control unit of a navigation system within the vehicle 60.

The external source 90 can be, for example, a cloud-based storage facility. The information from the external source 90 can be communicated wirelessly to the receiver 74 of the vehicle 60. In this example, the external source 90 provides weather condition data to the vehicle 60, which is utilized by the control module 70. The weather condition data can be collected from weather stations, news stations, from other vehicles out in the field as crowd-sourced weather condition data, remote connected temperature sensors, connected mobile device database tables, or can be collected in some other way. A person having skill in this art and the benefit of this disclosure could understand how to gather weather condition information.

The display 78 can be a display within a passenger cabin 94 of the electrified vehicle. The display 78 can be a touchscreen display. A user can interact with the display 78 as a human machine interface (HMI) to control features of the electrified vehicle 60. The display could be a navigation unit for the vehicle 60, for example.

The user input device 82 can be a portion of the display 78, or some device separate from the display 78, such as a toggle switch or button. In this example, the display 78 can show a current temperature of the passenger cabin 94 to an occupant of the electrified vehicle 60. The display 78 also provides an interface to make adjustments to a set temperature for the cabin 94. The set temperature is the user's desired temperature for inside the cabin 94

The display 78 could, for example show that an actual temperature inside the cabin 94 and a set temperature for inside the cabin 94 are both 68 degrees Fahrenheit. Through the user input device 82, a user can adjust the set temperature. The user, for example, may instead desire a temperature inside the cabin to be 72 degrees Fahrenheit. Accordingly, the user interacts with the user input device 82 to raise the set temperature to 72 degrees Fahrenheit. Although described as a single temperature, the set temperature could be a range of temperatures, say from 71-73 degrees Fahrenheit. The user can adjust the range using the user input device 82. Alternatively, the user's preferred set temperature may be stored in a memory portion of the control module 70 or another portion of the vehicle 60. The set temperature for a user could be part of a profile of the user stored in a cloud-based database.

In response to the actual temperature inside the cabin 94 now being less than the set temperature, the control module 70 activates the HVAC system 86 of the electrified vehicle 60. The activated HVAC system 86 then raises a temperature of the cabin from 68 degrees Fahrenheit to 72 degrees Fahrenheit. The HVAC system 86 is automatically adjusted to maintain the passenger cabin 94 at the set temperature.

The HVAC system 86 can be powered directly, or indirectly, from the battery pack 24. As can be appreciated, heating the cabin 94 requires more energy when a temperature outside the cabin 94 is relatively cold. Similarly, cooling the cabin 94 requires more energy when a temperature outside the cabin 94 is relatively hot.

The control module 70 can be a hybrid powertrain control module. The control module 70, in another example, can be part of an engine control module, a battery electric control module, etc. within the vehicle. The control module 70, in this example, includes a processor operatively linked to a memory portion. The example processor is programmed to execute a program stored in the memory portion. The program may be stored in the memory portion 76 as software code. The program stored in the memory portion may include one or more additional or separate programs, each of which includes an ordered list of executable instructions for implementing logical functions.

The processor can be a custom made or commercially available processor, a central processing unit (CPU), an auxiliary processor among several processors associated with the control module, a semiconductor based microprocessor (in the form of a microchip or chip set) or generally any device for executing software instructions.

The memory portion can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. The memory portion can also have a distributed architecture, where various components are situated remotely from one another, but can be accessed by the processor.

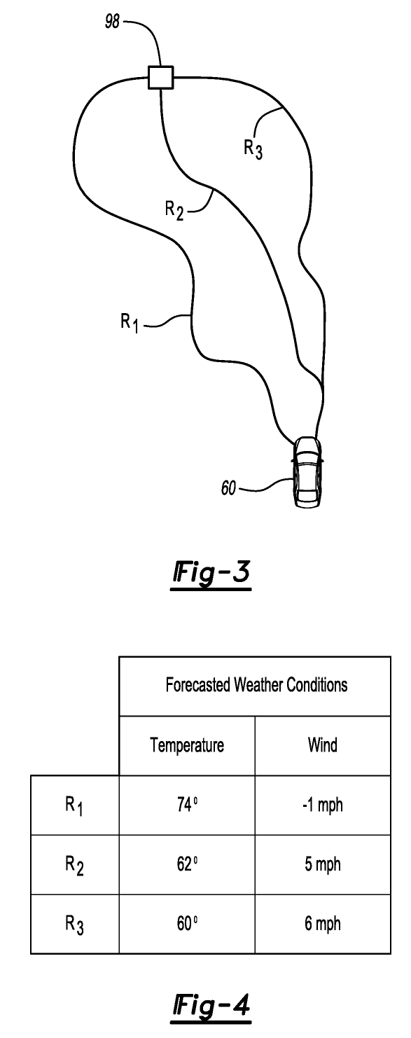

Referring now to FIG. 3 with continuing reference to FIG. 2, a user can interface with the display 78, the user input device 82, or both, to input a destination 98 for the electrified vehicle 60.

The destination 98 can be, for example, a city located a considerable distance away from the electrified vehicle 60. As can be appreciated, multiple routes can be taken by the electrified vehicle 60 to the destination 98. In FIG. 3, three such potential routes are shown as R₁, R₂, and R₃.

An amount of energy consumed by the electrified vehicle 60 when traveling to the destination 98 can vary depending on the route taken. The example vehicle 60 takes into account weather conditions along the potential routes R₁, R₂, R₃ to provide a preferred route to a user of the electrified vehicle 60. Of the potential routes R₁, R₂, R₃ the preferred route consumes the least amount of energy from the battery pack 24.

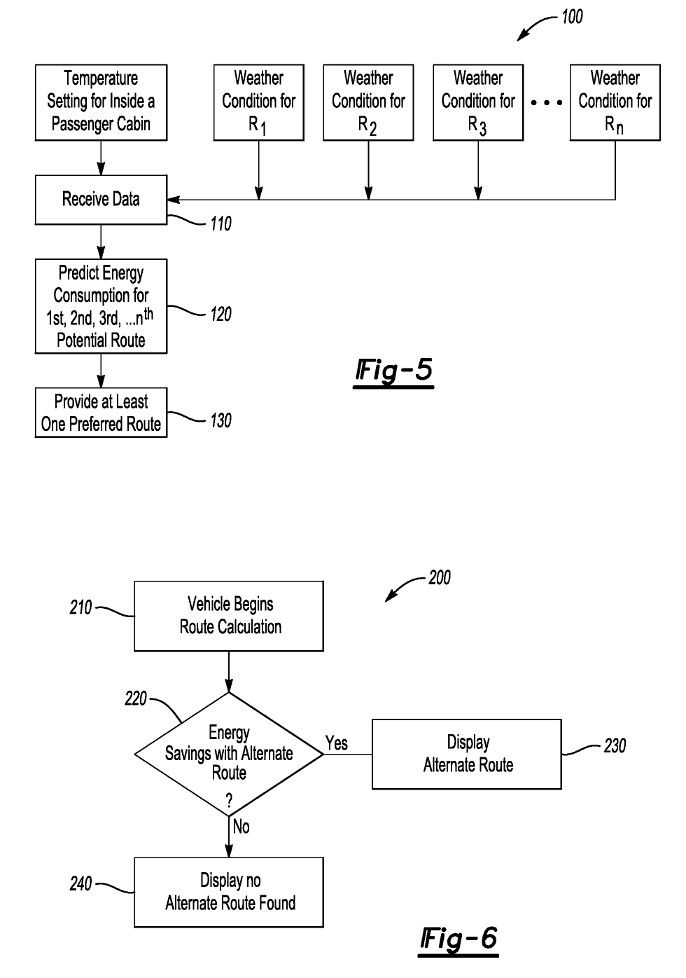

To facilitate calculating which of the routes R₁, R₂, R₃ will result in the electrified vehicle 60 consuming the least amount of energy, the receiver 74 receives forecasted weather conditions for each of the routes R₁, R₂, R₃ from the external source 90. The forecasted weather conditions can be stored within a memory portion of the control module 70 in a table as shown in FIG. 4.

In this exemplary embodiment, the forecasted weather conditions include a forecasted temperature, and a forecasted wind speed for each of the routes R₁, R₂, R₃. Other weather conditions could instead or additionally be used in other examples, particularly those weather conditions that influence energy consumption.

In this exemplary embodiment, a forecasted temperature along the route R₁ is higher than a forecasted temperature along the routes R₂ and R₃. Also, a wind speed along R₁ is a tailwind and the wind speed along routes R₂ and R₃ are headwinds.

In addition to the forecasted weather conditions, the control module 70 also monitors the set temperature for the passenger cabin 94. Here, as explained above, the set temperature for inside the cabin 94 is 72 degrees Fahrenheit. The set temperature is closer to the forecasted temperature along the route R₁ than along the routes R₂ or R₃. Thus, maintaining the cabin 94 at the set temperature when the vehicle 60 travels along the route R₁ to the destination will likely consume less energy than were the vehicle 60 to travel along the routes R₂ or R₃ to the destination 98.

The control module 70 utilizes the forecasted weather conditions and the set temperature to predict an energy consumption along each of the routes R₁, R₂, R₃. In this example, the energy consumption due to weather conditions would be the least if the electrified vehicle 60 were to travel along route R₁ to the destination 98. More energy would be consumed along the routes R₂ and R₃ to combat the headwinds, and to raise the temperature of the passenger cabin 94 to the set temperature.

Referring now to FIG. 5 with continuing reference to FIGS. 2-4, the flow of an exemplary route planning method 100 utilized by the control module 70 includes a step 110 of receiving data. The data includes the set temperature for inside the passenger cabin 94, as well as a weather condition for potential routes R₁, R₂, R₃, R_{N}. The number of weather conditions and the types of weather conditions can vary depending on the number of potential routes to a destination.

The control module 70 then, at the step 120, uses the set temperature and the weather conditions to provide a predicted energy consumption for each of the routes R₁, R₂, R₃, R_{N}. Based on the predicted energy consumptions, the method 100, at a step 130, can then provide one or more preferred routes to a user of the electrified vehicle 60. A preferred route is, in this example, a route that will consume the least amount of energy as the vehicle 60 travels to the destination. That is, the preferred route is the route or routes within the plurality of potential routes R₁, R₂, R₃, R_{N} with the predicted energy consumption being the lowest.

The step 120 can, in some embodiments, further utilize an optimal powertrain temperature setting when providing the predicted energy consumption. The optimal powertrain temperature setting including a preferred temperature setting for the battery pack 24 of the vehicle 60, the motor 22, the generator 18, or some combination of these. The preferred temperature setting can be a range of temperatures.

In some examples, the preferred route is provided to the user by initiating a display of the preferred route on the display 78 within the electrified vehicle 60. For example, the route R₁ may be calculated by the control module 70 to consume the least amount of energy. Accordingly, the R₁ can be displayed on the display 78 to the user as the preferred route.

The control module 70 can use various other factors when calculating the routes R₁, R₂, R₃, R_{N} predicted to consume the least energy. For example, differences in altitude or road grades between the routes R₁, R₂, R₃, R_{N} could be provided to the control module 70 at this step 110, and current traffic conditions for each of the routes R₁, R₂, R₃, R_{N} could be provided to the control module 70. The control module 70 thus, in this example, does not need to calculate the preferred route based only on weather conditions and a user's preferred set temperature. Instead, these bits of information improve the overall accuracy of the calculation to establish the preferred route.

Variations of the method 100 can be implemented as the electrified vehicle 60 is moving to the destination 98. For example, say the electrified vehicle 60 is traveling along the route R₁ to the destination 98, and a weather condition along the route R₂ changes such that R₂ becomes the route that will result in the least energy consumption.

The control module 70 can initiate an alert on the display 78 prompting the user to switch the vehicle 60 to the route R₂. The prompt can include some indication of the energy savings resulting from the switch. The alert could, for example, communicate to the driver that a range of the electrified vehicle 60 could be extended by say, 20 miles, if the driver were to switch from the route R₁ to the route R₂. The potential energy savings is thus provided to the driver. The prompting, in this example, occurs only if there is an energy consumption savings associated with the switch from the route R₁ to the route R₂. In some examples, a certain threshold savings, say 5 miles in range, must be saved in order for the control module 70 to prompt the user to make the switch from the route R₁ to the route R₂.

FIG. 6 illustrates the flow of a portion of a method 200 utilized by the control module 70 of FIG. 2 to reveal alternative, energy efficient routes to the user. At a step 210, the method 200 continually calculates routes to the destination. New routes can be identified based on roads opening or closing, traffic problems clearing, etc. At a step 220, the method 200 determines whether any of the routes to the destination provide an energy savings. That is, step 220 assesses whether there is a reduction in energy consumption associated with traveling along an alternate route.

If there is an energy savings associated with an alternate route, the method 200 displays the alternate route to the user at a step 230 as a new preferred route. If there is no energy savings associated with an alternate route, the method 200 moves to the step 240 where no new route is displayed.

Yet another variation of the method 100 could involve the user requesting a preferred route for driving to the destination 98. The request could be made through the display 78, or the user input device 82. The user may make the request to increase a range of the vehicle 60.

In response to the user request, the control module 70 can prompt the user to confirm the user-preferred temperature setting for the cabin 94 during the drive to the destination, and a day and time for the drive. The prompting may be a message displayed on the display 78.

The control module 70 then collects the forecasted weather conditions for the potential routes to the destination. The forecasted weather conditions can be obtained from the external source 90. The forecasted weather conditions can include information from online databases.

The control module 70 next identifies at least one of the potential routes as being an optimal route, and can show an energy savings associated with one or more of the routes. The routes could each be displayed with an associated message, for example. Example messages could include “ROUTE 1 SAVES 20 MILES IN RANGE,” “ROUTE 2 SAVES 50 MILES IN RANGE,” “YOU WILL RECEIVE A RANGE OF 65 MILES ON ROUTE 2 IF YOU LEAVE AT 3:50 P.M. ON THURSDAY AND LEAVE THE INTERIOR CLIMATE CONTROL AT 78 DEGREES FAHRENHEIT,” etc.

In some examples, the control module 70 establishes one or more energy consumption base temperature points using forecasted weather conditions along each of the potential routes. The energy consumption base temperature points represent the average ambient temperature that the vehicle (including the battery pack and vehicle interior) will be exposed to along the driving route. Different segments of the potential routes can include different energy consumption base temperature points.

The control module 70 can compare both the user-preferred temperature setting for the cabin 94 and the ideal operating temperature of the battery pack 24 to the base temperature points. The comparison can identify which will be a bigger energy drain in deviation from the base temperature points, which can influence the route that is selected.

For example, a proposed Route A could have a base temperature point at 70 degrees Fahrenheit while a proposed Route B has a base temperature point at 80 degrees Fahrenheit. In this example, the ideal operating temperature of the battery pack is 78 degrees Fahrenheit, and the user-preferred temperature setting is 70 degrees Fahrenheit. The control module 70 then calculates that there would be a bigger energy drain traveling along Route A than along Route B. This calculation involves calibrated values of expected energy drain based on deviation from base temperature point for both user-preferred temperature setting for the cabin 94 and ideal operating temperature of the battery pack. In this example, the control module 70 assessed that more energy would be spent to keep the battery 8 degrees Fahrenheit warmer on Route A than the combined energy spent to keep the battery 2 degrees Fahrenheit cooler and the interior 10 degrees Fahrenheit cooler.

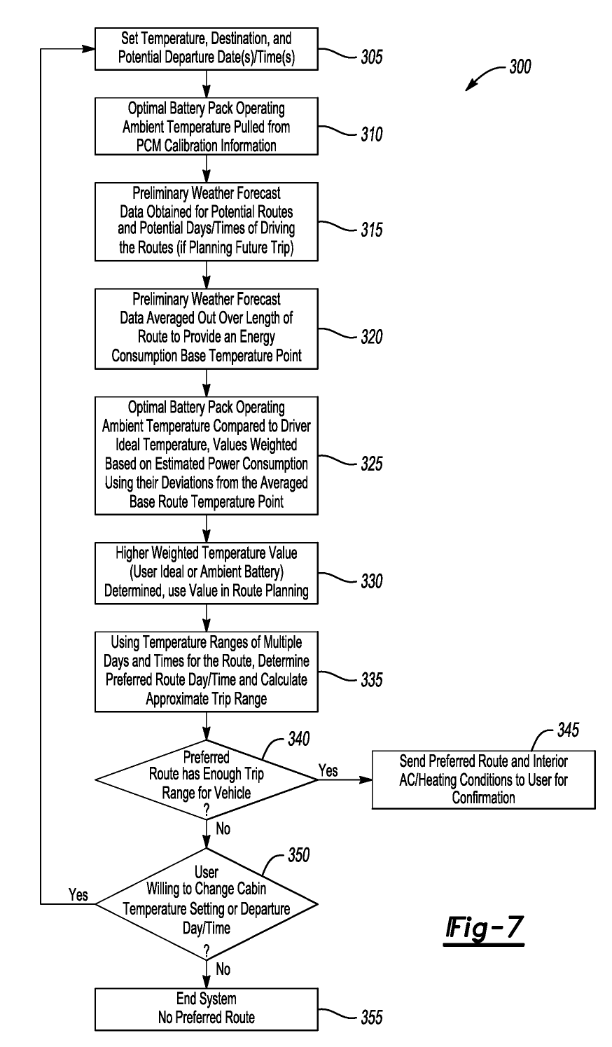

Referring now to FIG. 7 with continuing reference to FIG. 2, in another exemplary embodiment, the control module 70 uses a method 300 to identify a preferred route. At the step 305, the user enters a set temperature for the cabin 94, a destination, and a departure date and time. The departure date and time can be a range for times, days, or both.

At the step 310, the optimal temperature for the battery pack 24 is provided to the control module 70. The powertrain control module (PCM) of the vehicle 60 can provide this optimal temperature information.

At a step 315, the forecasted weather conditions for potential routes to the destination is compiled. At the step 320, the forecasted weather conditions along the potential routes are averaged for each potential route to provide an energy consumption base temperature point. At the step 325, the optimal battery pack operating temperature is compared to the cabin temperature setting from the step 305. For each potential route, the energy consumption associated with maintaining the optimal battery pack operating temperature and the cabin temperature setting is estimated and weighted based on a deviation from the energy consumption base temperature point.

Weighting the deviations from the energy consumption base temperature point can be required because 1 degree Fahrenheit of deviation for the user-preferred temperature setting for the cabin 94 is not an equivalent energy drain to 1 degree Fahrenheit of deviation for the ideal battery pack operating temperature.

At a step 330, the higher weighted temperature value (the cabin temperature setting or the optimal battery pack operating temperature) is used when selecting a route from among the plurality of potential routes.

Next, at a step 335, the method 300 uses temperature ranges for the plurality of potential routes across multiple days and times, and then calculates the preferred route, departure day, and departure time. The preferred route, for purposes of this example, is the most energy efficient route from among the plurality of potential routes. Additionally, at the step 335, the method 300 can be reiterated for a range of potential travel days and times that the user can plan to leave on.

As an example, a user can compare calculated approximate trip ranges for the coming week. Monday and Tuesday are forecasted to be cold and the calculated approximate trip range is 120 miles for both of those days. But Wednesday is forecasted to be warm and its calculated approximate trip range is 150 miles. These comparisons for potential travel days and times would be presented to the user via the in-vehicle HMI or mobile device to allow them to make an informed decision on their travel day and time. An option can be provided for the user to search for only potential travel days and times within a designated time frame.

At a step 340, the method 300 assesses whether the preferred route has enough trip range in the designated potential travel days and times. In other words, can the vehicle 60 traveling the preferred route arrive at the destination without depleting the battery pack 24. If yes, the method 300 moves to the step 345 where the preferred route is sent to the user for confirmation along with the set temperature. The step 340 can take into account charging stations, or planned charging stops input by the user for charging the vehicle 60.

If the preferred route lacks trip range, the method 300 moves from the step 340 to the step 350 where the method 300 requests that the user alter temperature settings, the departure day, the departure time, or some combination of these. The step 350 can additionally include requesting the user to enter desired locations where the user will stop and charge the battery pack 24. The step 350 can instead, or additionally, automatically assess and suggest stops suitable for charging the battery pack 24.

Adjusting these variables can result in less energy consumption and result in the preferred route having enough trip range for the vehicle 60. If the user is willing to make changes to one or more of these variables, the method 300 returns to the step 305. If the user is not willing to change one or more of these variables, the method 300 moves to the step 355 and reports that no preferred route can be identified.

The forecasted weather conditions can be used to determine ideal temperature to extend the range of vehicles as described above. The forecasted weather conditions can provide other benefits as well. For example, the forecasted weather conditions can help to identify routes that would have safer road conditions, for example, by avoiding areas with ice or heavy rain. The vehicle could also be preset to avoid certain conditions undesirable to the user, such as fog or snow.

Any of the embodiments could incorporate a severe weather warning functionality. The warnings could appear on the display 78 along with alternative routes that would help the user to avoid the severe weather. In some examples, the alternative routes are the fastest routes that help the user avoid the severe weather. The severe weather warning can allow the user to prepare for travel by giving the user time to stop at a hotel, stop for food, stop for gas, etc.

An example warning can include a message on the display 78 stating “SEVERE BLIZZARD DETECTED IN 1.5 HOURS. ALTERNATE ROUTE ADDS 2 HOURS. WOULD YOU LIKE TO STOP, CONTINUE, OR USE ALTERNATE ROUTE?” The message can thus prompt the user to transition to the alternative route and indicate how much time will be added to the journey if the user takes the alternative route.

In some example embodiments, the locations of charging stations along the routes could be relayed to the user. If the routes to the destination require more miles than the available range of the vehicle, the control module can plan breaks along the route that have charge port accessibility. This can also be used for longer trips where recharging would be needed along with rest stops.

Features of the disclosed examples include an electrified vehicle that can provide preferred route information to a user that is based on predicted weather conditions, as well as the user's preferred set temperatures for a passenger compartment. The temperature-optimal, preferred route can be used to provide confidence for users who are unsure that they can reach their destination. Existing vehicles with navigation and infotainment system can potentially be retrofitted to include the features of this disclosure.

Providing the preferred route information connects users to their vehicle and provides them with control over their energy consumption. The preferred route information can educate users about how cabin cooling and heating can influence range.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. An electrified vehicle assembly, comprising:
a controller that uses both a set temperature for inside a passenger cabin and a weather condition outside the passenger cabin to provide a predicted energy consumption for an electrified vehicle along at least one potential route to a destination.

2. The electrified vehicle assembly of claim 1, wherein the set temperature for the passenger cabin is a user-adjustable range of temperatures.

3. The electrified vehicle assembly of claim 1, wherein the weather condition outside of the passenger cabin comprises a forecasted weather condition for the at least one potential route.

4. The electrified vehicle assembly of claim 1, wherein the at least one potential route is a plurality of potential routes, and the controller is configured to compare the predicted energy consumption for each of the plurality of potential routes and to provide at least one preferred route.

5. The electrified vehicle assembly of claim 4, further comprising a display screen within the passenger compartment, the controller providing the at least one preferred route by initiating a display of the at least one preferred route on the display.

6. The electrified vehicle assembly of claim 4, wherein the at least one preferred route is the route or routes within the plurality of potential routes with the predicted energy consumption being the lowest.

7. The electrified vehicle assembly of claim 1, wherein a potential energy savings is provided to a user if another of the plurality of potential routes to the destination is selected.

8. The electrified vehicle assembly of claim 1, wherein the controller is a hybrid powertrain control module.

9. The electrified vehicle assembly of claim 1, wherein the weather condition comprises a forecasted temperature.

10. The electrified vehicle assembly of claim 1, wherein the weather condition comprises a forecasted wind speed.

11. A route planning method, comprising:
using both a set temperature for inside a passenger cabin and a weather condition outside the passenger cabin to provide a predicted energy consumption for at least one potential route to a destination.

12. The route planning method of claim 11, wherein the set temperature for the passenger cabin is a user-adjustable range of temperatures.

13. The route planning method of claim 11, wherein the weather condition outside of the passenger cabin comprises a forecasted weather condition for the at least one potential route.

14. The route planning method of claim 11, wherein the at least one potential route is a plurality of potential routes, and further comprising comparing the predicted energy consumption for each of the plurality of potential routes to provide at least one preferred route.

15. The route planning method of claim 14, further comprising displaying the at least one preferred route on a display.

16. The route planning method of claim 14, wherein the at least one preferred route is the route or routes within the plurality of potential routes with the predicted energy consumption being the lowest.

17. The route planning method of claim 14, wherein a potential energy savings is provided to a user for at least some of the plurality of potential routes to the destination.

18. The route planning method of claim 11, wherein the weather condition comprises a temperature.

19. The route planning method of claim 11, wherein the weather condition comprises a wind speed.

20. The route planning method of claim 11, further comprising using an optimal powertrain temperature setting when providing the predicted energy consumption, the optimal powertrain temperature setting including a preferred temperature setting for a battery pack of a vehicle having the passenger cabin, an electric motor of the vehicle, or both.
